(19) United States
(12) Patent Application Publication
(10) Pub. No.: US 2013/0131849 A1
(43) Pub. Date: May 23, 2013

(54) System for adapting music and sound to digital text, for electronic devices

(71) Applicant: Shadi Mere, (US)

(72) Inventor: Shadi Mere, (US)

(21) Appl. No.: 13/301,636

(22) Filed: Nov. 21, 2011

(51) Int. Cl. G06F 17/00

(52) U.S. Cl. 700/94

(57) ABSTRACT

A software system application for Tablets and smart phones that will adapt music and sound effects to digital music and track where the user is reading and adjust and adapt the sound and music delivery based on the reader text location or pace. The system will generally acoustically coordinate the music data with the text data context based on matching characteristics such as mood, tempo, mode and loudness. The system will introduce sound effects based on the contents of the text when the user has reached that location in the text. The system will use data from the device to locate the text being read at the time it is being read to adapt the music or sound effects.

### FIELD OF THE INVENTION

The invention relates generally to mobile phones, electronic readers, tablet devices and any other electronic devices capable of displaying text. Specifically, the invention is directed to a software algorithm and delivery system application, which provides an adaptive delivery of music and sound effects to digital text, eBooks and webpages. The software algorithm tracks the text sections and pages read by the user and adapt the music and/or sound effects to coordinate with the location of the reader in the text and/or pace of the reader.

### BACKGROUND OF THE INVENTION

Currently digital text for fiction and nonfiction literature is delivered on Personal computers, electronic tablets and smart phones. These literary works are distributed through a variety of means, but are in a media suitable for electronic display.

Music, sound scores and sound effects are not linked dynamically to digital text being read, nor track with the events of what the digital text is conveying, even though the electronic device commonly has audio capability.

The sound is either separate on a different application on the same device or on a different device altogether.

When the sound is on the same device it does not track the read text location or the events of what the digital text is conveying. This creates a disassociated experience unlike movies or video games where the soundtrack keeps pace with the story and events, delivering an audio relevant experience.

When the sound is played on the same device or application, it is played based on a trigger event such as clicking a location on the display such as an image of a character in a children's story.

When the audio file is played on the same device or application, it is played based on a trigger event such as clicking on a different window page

### SUMMARY OF THE INVENTION

Concordant and consistent with the present invention, a software application tracks the users reading position in written text and delivers music and sound according to the text being read. This system can provide general music soundtrack capability, sound effects for singular events in the text, or general background noises and sound effects_to provide a heightened experience to the reader of the text.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a perspective view of a tablet device to an embodiment of the present invention; it contains an example of a device capable of tracking the position of the readers eye in relation to the text.

FIG. 2 is a perspective view of a Smart phone device to an embodiment of the present invention; it contains an example of a device capable of tracking the general position of the reader in relation to the text.

FIG. 3 is a flow diagram of a method for matching relevant audio files to digital text.

FIG. 4 is a flow diagram of a programmable logic method to match relevant characteristics of audio files to digital text.

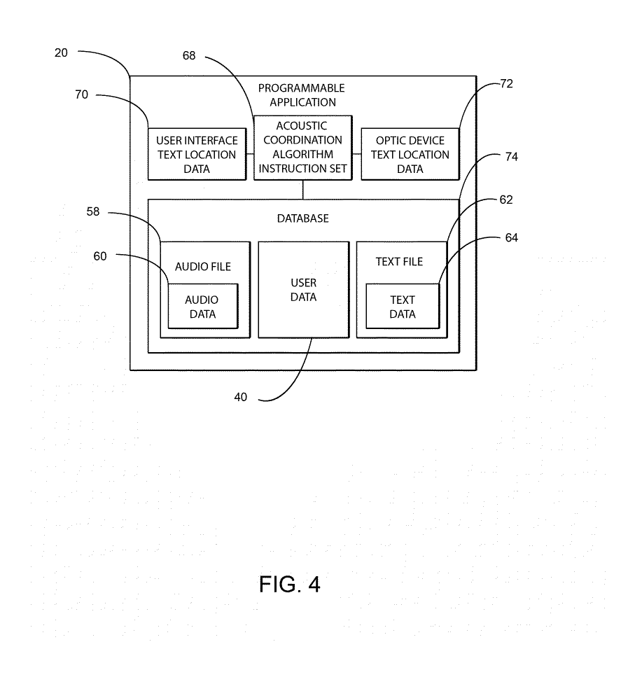

FIG. 5 is a schematic flow diagram of a method for adapting audio data to text data using multiple signal sources.

### DETAILED DESCRIPTION OF EXEMPLARY EMBODIMENTS OF THE INVENTION

The following detailed description and drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

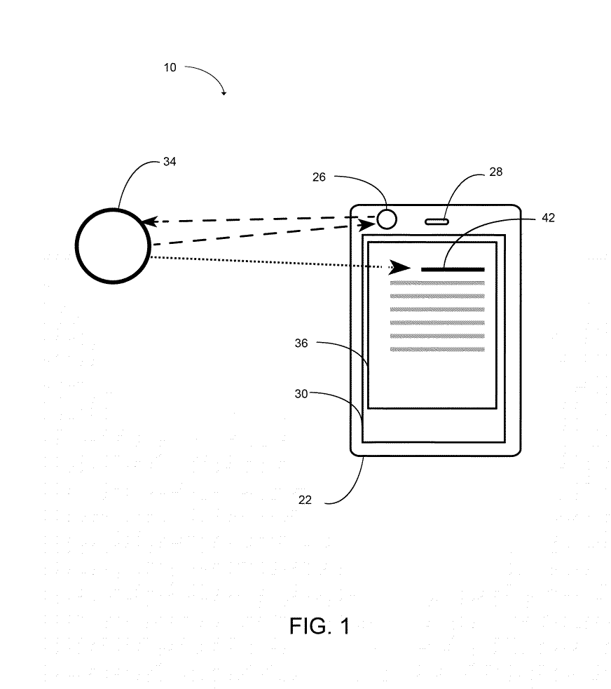

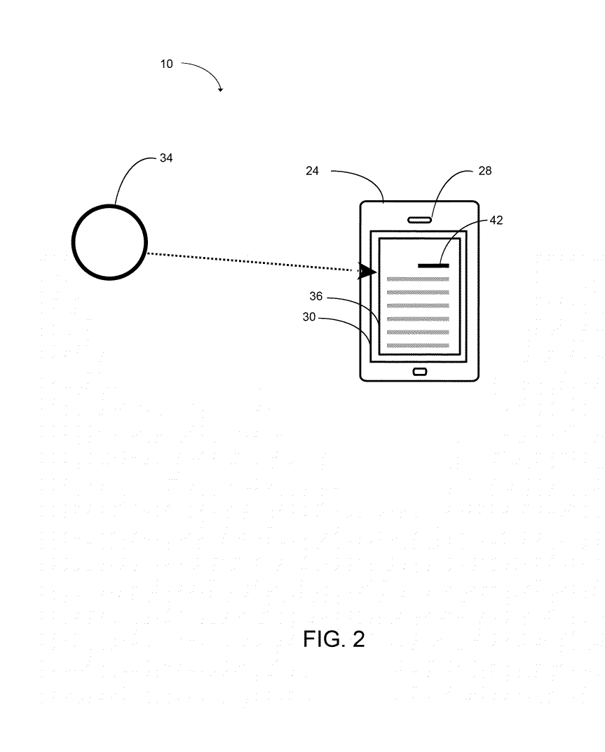

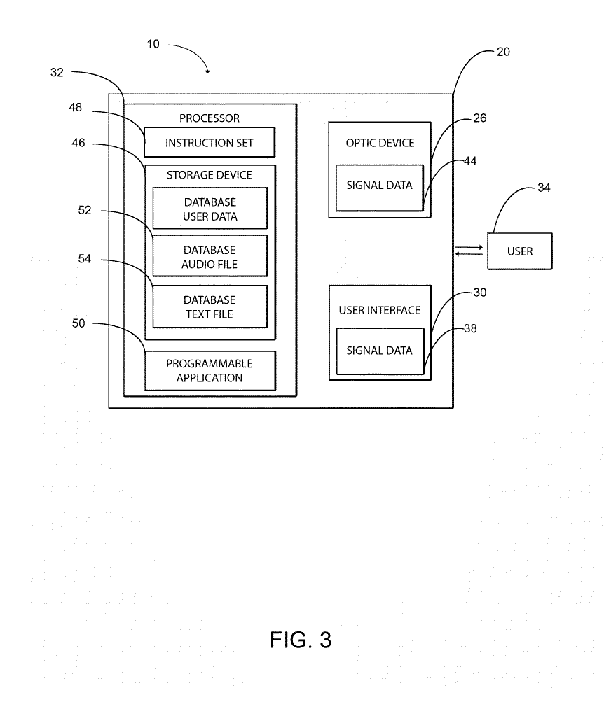

FIGS. 1-2-3 illustrate an adaptive audio playback system 10 according to an embodiment of the present invention. As a non-limiting example, the audio playback system 10 can be any Electronic device 20, Electronic tablet 22, Smart phone 24, or system capable of displaying text and playing audio. The playback system 10 can include any number of components as desired. The playback system 10 can be integrated in any user environment.

In certain embodiments, the E-Tablet device 22 includes, an optic device 26, an audio delivery component 28 such as a speaker or an auxiliary headphone jack, a user interface 30, the user interface can include but not limited to, a display, a touch panel, buttons or/and sliders to adjust user inputs, and sensors.

In certain embodiments, the Smart Phone device 24 includes, an audio delivery component 28 such as a speaker or an auxiliary headphone jack, and a user interface 30.

In certain embodiments, the E-Device 20 includes an optic device 26, an audio delivery component 28, a user interface 30, and a processor 32.

In certain embodiments, the E-Device 20 includes a user interface 30 the user 34 uses to view images and/or text 36.

In certain embodiments, the E-Device 20 includes a user interface 30 representing a plurality of user inputs, such as but not limited to, scrolling, page turn, reading speed, audio volume settings, text size and display zoom, all of which are tracked as user interface signal data 38 and recorded as user data 40.

In certain embodiments, the E-Device 20 includes a user interface 30, which the user 34 uses to enter and record user data 40. As a non-limiting example, the user data 40 can include the user preferred music type, mood or genre, the user reading speed history, the user personal settings for the E-Device 20. As a further non-limiting example, a secondary software (not shown) can be used to generate a user data 40. As a further non-limiting example, the user data 40 can be downloaded from an external device such as a personal music player or a laptop or from remote cloud service storage.

In certain embodiments, the E-Device 20 includes an optic device 26 such as but not limited to a camera to track the user 34 eye gaze location and/or movements and record the relative location to the text location 42 being viewed by the user 34 and displayed on the device and record it as the optic device signal data 44.

In certain embodiments, the E-Device 20 includes an optic device 26 such as but not limited to a laser to track the user 34 eye gaze location and/or movements.

In certain embodiments, the E-Device 20 includes an optic device 26 such as but not limited to an Infrared sensor to track the user 34 eye gaze location and/or movements.

In certain embodiments, the processor 32 includes, a storage device 46, an instruction set 48, and a programmable logic application 50.

In certain embodiments, the storage device 48 includes a database of audio files 52, a database of text files 54, and a database of user data 56.

The system 10 triggers relevant audio file 58 to playback when the user 34 is reading a particular text location 42. The audio file 58 can be predetermined, it can be selected from a group based on the user data 40, it can be custom loaded by the user 34, or can be modified or selected differently based on the reading speed or capability of the user 34. The system 10 can also be loaded with foreign language audio files and playback a translation based on the text location 42 or based on the number of times a word is re-read in the text. The system 10 can select audio files intelligently based on the particular word re-read, retrieving the audio file 58 related to the particular word.

One embodiment of the system 10 uses an optic or laser based device 26 capable of tracking the user 34 eye location in relation to the text 36 displayed. The system compares the eye's known or estimated location relative to the known or estimated location of the text on the screen. When the user 34 eye reaches a particular area of text location 42 that has audio relevant to it, the system 10 triggers the playback of a relevant audio file 58, which could include music, speech, single event sound effects or a looped playback of sounds relevant to the content of that particular area of text.

In another system of the invention, an optic or laser device 26 tracks the movement of the user eye relative location, determining the position of the user in the text by recording how many times the eye begins a new line of text. When the system determines that the reader has reached a particular area of text 42, based on the number of lines read, the system triggers the playback of a relevant audio file 58.

In another system 10 of the invention, the user location in the text 42 is estimated based on the reading speed of the user/reader. The readers speed may be recorded from previous uses of the device or calculated based on the elapsed time spent reading the current file combined with the current page or text area displayed 36. Audio files are played based on a timer, which estimates the readers position in the text 42 based on reading speed.

In another system of the invention, the readers location in the text 42 is estimated based on the page or area of text displayed 36.

In another system 10 of the invention, the readers location in the text 42 is estimated based on reader input such as amount and duration of the use of a scrolling function, return key or other movements or inputs from a device such as a mouse which could be used to infer the readers location in the text 42.

In certain embodiments, the programmable application 50 will categorize the audio file 58 into audio data 60 based on audio characteristics such as but not limited to, translation data, tempo data, beats per minute data, sections data, pitch data, mode data, loudness data, and mood data. As a further non-limiting example, a secondary software (not shown) can be used to generate and categorize the audio data 60, such as Live™ software by Appleton AG.

In certain embodiments, the programmable application 50 will categorize the text file 62 into text data 64 based on text context characteristics such as but not limited to, translation data, mode data paragraph data, events data, page data, paragraph length data, scene data, tempo data, sound effects data, loudness data, and mood data.

In another system of the invention, the programmable application 50 will use an acoustic coordination algorithm instruction set 68 to acoustically coordinate relevant text files 62 and audio files 58 based on the matching characteristics of audio data 60 and text data 64, the programmable application logic will then generate audio parameters such as but not limited to, loop length, fade out, loudness, timing, trigger events and transitions, all of which will be variable, to be adjusted, prioritized and set by the programmable application algorithm.

The programmable application 50 will use the user interface signal data 38 to generate the user interface text location data 70 that has a calculated general position of the text location 42 being read by the user 34. The programmable application 50 will use the optic device text location signal data 44 to generate the optic device text location data 72 that has an accurate position of the text location 42 being read by the user 34.

The programmable application 50 will adjust the audio parameters based on the user data 40.

The audio file 58 priority and parameters will be dynamically adjusted and set based on the estimated user interface text location data 70 and/or exact position from the optic device text location data 74 of the readers position in the text 42 if the device is equipped with an optic device 26. As a further non-limiting example, the resulting audio file will have a unique file extension. As a further non-limiting example, a secondary software (not shown) can be used to acoustically coordinate relevant text files 62 and audio files 58, and direct edit the resulting audio file parameters, the resulting files can be downloaded into the device from an external source such as the internet, and played with predetermined trigger events based on the estimated user interface text location data 70 and/or exact position from the optic device text location data 74 of the readers position in the text 42 if the device is equipped with an optic device 26.

The programmable application 50 will prioritize the order and synchronized broadcast timing of the audio file 58 to coordinate with trigger events in the text.

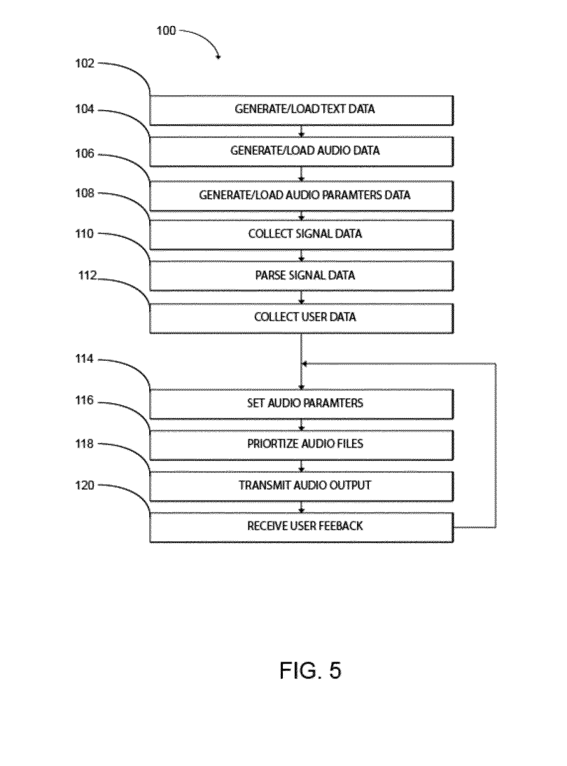

FIG. 5 illustrates a method 100 to adjust and adapt the sound and music delivery based on the reader text location 42.

In step 102 the programmable application 50 generates the text data 64 from the programmable application database 74, or load the data from another system (not shown).

In step 104 the programmable application 50 generates the audio data 60 from the programmable application database 74, or load the data from another system (not shown). The audio files are predetermined files that are chosen or created based on the context of the text file 62 and/or created to be more specific and detailed based on the text data 64 to match the pragmatic and semantic characteristics that are essential to the context of the text, these audio files could be composed as a score to accompany the text file 62, or are sound effects for specific events in the text, or general music, created previously, that complement the context of the text file 62.

In step 106 the programmable application 50 generates the audio parameters data such as music loop length, general trigger events sequence such as turning a page or moving from one paragraph to another that has a different context, or based on specific trigger events in the text such as a thunder storm, also the parameters can be loaded from another software (not shown).

In step 108 the signal data is collected from the optic device text location data 72 and from the user interface text location data 70.

In step 110 the data is parsed to calculate the position of the text being read 42, the exact position and estimated position of the reader are compared and aggregated by the acoustic coordination algorithm 68. In devices such as the E tablet 22 which has an optic device 26, the location of the text being read is determined more accurately than an estimated position in other devices such as a smart phone 24 which has to rely on the user interface interactions and inputs to calculate the location of the text being read by the user 34.

In step 112 the programmable logic 50 collects the user data 40, which has the specific preferences of the user 34.

In step 114 the acoustic coordination algorithm 68 will set the audio files parameters according to the aggregated parsed result in step 110 that indicates the position of the text location 42. The parameters will also be adjusted by the user data in step 112 to reflect the user preferences in the user data 40. As a non limiting example, the file loop length parameter will be adjusted based on the readers speed, the longer it takes the reader to read a page the longer the loop length is set, in addition, the loudness parameter set by the user 34 and collected in the user data 40 will be adjusted for the loop to reflect the user preference.

In step 116 the acoustic coordination algorithm 68 will prioritize the sequence order transmission of the audio files, certain files will be transmitted once to accompany certain pages or sections of the text, other files, such as sound effects files will be repeated throughout the text based on the order sequence in this step.

In step 118 the audio files are transmitted through the audio file component 26.

In step 120 the user 34 can interact with the user interface 30 in order to provide feedback and adjust preferences stored in the user data 40.

What is claimed is:

1. An audio playback system compromising at least one file capable of displaying readable text on an electronic device, a tracking mechanism for tracking a users reading position in the written text, at least one audio file and a processing device capable of initiating the playback of the at least one audio file at a relevant area in the text when the tracking mechanism indicates to the processor that the user is reading in the relevant area of the text.

2. An audio playback system according to claim 1 wherein the processing device is further capable of initiating the playback of an audio file which corresponds to a word of written text, said processing device further capable of determining when the word of written text is re-read by a reader, said processing device further capable of initiating the playback of the audio file which corresponds to the word.

3. An audio playback system according to claim 1 wherein the tracking mechanism is an optic device capable of measuring the movement of the users eye in relation to the text.

4. An audio playback system according to claim 1 wherein the tracking mechanism is an optic device capable of measuring the location of the user's eye in relation to the text.

5. An audio playback system according to claim 1 wherein the tracking mechanism is a laser device capable of measuring the location of the user's eye in relation to the text.

6. An audio playback system according to claim 1, wherein the tracking mechanism is a signal from the text display device indicating what portion of the text is currently displayed to the reader.

7. An audio playback system according to claim 6 wherein the signal from the text display device indicating what portion of the text is currently displayed to the reader is a page location in the text.

8. An audio playback system according to claim 6 wherein the signal from the text display device indicating what portion of the text is currently displayed to the reader is a cursor location in the text.

9. An audio playback system according to claim 6 wherein the signal from the text display device indicating what portion of the text is currently displayed to the reader is the cumulative signal from a scrolling device.

10. An audio playback system according to claim 1 wherein the mechanism for tracking a users position in the written text is an algorithm which calculates position based on the readers reading speed.

11. An audio playback system according to claim 1 wherein the mechanism for tracking a users position in the written text is an algorithm which calculates position based on an average readers reading speed.

12. An audio playback system according to claim 1 wherein the mechanism for tracking a users position in the written text is the area of text currently displayed.

13. An audio playback system according to claim 1 wherein the audio file is played in a loop based on a users position in the written text currently displayed.

14. An audio playback system according to claim 1 wherein an algorithm will acoustically coordinate the play of the end of the audio file with the next audio file based on the users position in the written text currently displayed.

15. An audio playback system according to claim 1 wherein multiple audio file are played simultaneously based on the a users position in the written text currently displayed to introduce sound samples related to events related to the context of the text.

16. An audio playback system according to claim 1 wherein the arrangement of audio samples play is coordinated based on an algorithm logic that matches the users position in the written text with the written text pragmatic and or semantic context.

17. An audio playback system according to claim 16 wherein the mood of the written text is characterized into distinct logical emotional experiential attributes from a group including, but not limited to, excitement, sadness, happiness, anxiety, joy, frustration, despair, and suspense, based on text pragmatic and/or semantic context.

18. An audio playback system according to claim 16 wherein the algorithm logic selects prioritizes and plays music files based on matching characteristics between music data and text data displayed.

19. An audio playback system according to claim 16 wherein the algorithm logic acoustically coordinate the music data with the text data based on matching context characteristics including but not limited to mood, tempo, mode, events, translation and loudness.

20. An audio playback system according to claim 16 wherein the algorithm logic selects, prioritizes and plays music files based on the user preferences and feedback.
